(19) United States
(12) Patent Application Publication
(10) Pub. No.: US 2026/0336380 A1
(43) Pub. Date: Oct. 29, 2026

(54) SYSTEM AND METHOD OF OPERATING HYBRID POWERTRAIN SYSTEM WITH FRICTION SLIP COUPLING

(71) Applicant: Deere & Company, Moline, IL (US)

(72) Inventors: Deven P. Wieland, Independence, KS (US); Briton T. Eastman, Coffeyville, KS (US); Randall L. Long, Coffeyville, KS (US)

(21) Appl. No.: 19/193,379

(22) Filed: Apr. 29, 2025

(51) Int. Cl. B60K 6/48; F16D 7/02

(52) U.S. Cl. CPC B60K 6/48; F16D 7/025; B60K 2006/4825

(57) ABSTRACT

A device may include an internal combustion engine configured to rotate a crankshaft output with an engine torque, wherein the crankshaft output is coupled to rotate an electric machine output shaft via a friction slip coupling. The friction slip coupling includes a first coupling shaft coupled to the crankshaft output via a first positive drive and is coaxially aligned along a rotational axis with a second coupling shaft. The second coupling shaft is coupled to the electric machine via a second positive drive. A disc pack is attached between the first coupling shaft and the second coupling shaft and has a set torque which is a maximum torque the disc pack can transfer from the first coupling shaft to rotate the second coupling shaft without slipping. The friction slip coupling limits the engine torque transmitted to the electric machine output shaft based on the set torque.

### FIELD OF THE DISCLOSURE

The present disclosure relates generally to a hybrid powertrain which uses a friction slip coupling to limit the torque output of an internal combustion engine crankshaft to drive a powertrain component. More specifically, the present disclosure relates to a friction slip coupling used to prevent damage to an electric machine driven by the crankshaft output of a piston powered internal combustion engine.

### BACKGROUND

To improve efficiency, work machines can use hybrid powertrains with an internal combustion engine as a primary power source to generate power by burning fuel and oxygen in a combustion chamber. The internal combustion engine can be controlled to operate at some desirable setting, such as at a constant speed, the most efficient speed for a given load, or at a speed at which the engine produces its peak torque to output the mechanical power needed to operate a work machine. At this setting, the engine may produce more or less power or torque than the engine needs to meet its instantaneous power or load requirements for the performance the operator demands. A second power unit, such as an electric motor/generator (or electric machine), can be connected to the engine's mechanical output to convert mechanical power into a form (such as electrical power) that can be stored when the engine produces excess power. The second power unit can also be designed to convert stored power back into mechanical power which can be combined with the engine to boost the engine's output when the engine, by itself, produces insufficient power.

One known type of internal combustion engine includes reciprocating pistons, each housed to slide up and down within a cylinder. Each cylinder is enclosed at one end by a cylinder head and each piston is connected by a connecting rod which extends out of the opposite open end of the cylinder to a crankshaft. The enclosed portion of the cylinder forms a combustion chamber in which fuel and oxygen burn to create a pressure wave of hot gases that expand to force the piston downwards. Because each connecting rod couples each piston to the crankshaft, each downward or upward stroke of each piston in its cylinder causes a corresponding rotation of the crankshaft. Generally, in such internal combustion engines, the engine is configured to ignite a fuel/air mixture to produce combustion strokes in each cylinder sequentially. The force with which each combustion stroke pushes down each piston generates a corresponding torque peak at the crankshaft output, as the crankshaft rotates through the sequential combustion stroke of each connected piston.

A flywheel can be attached to the crankshaft to smooth the power and torque peaks the engine outputs through the rotating crankshaft and to maintain sufficient angular momentum to keep the engine rotating between combustion strokes. The driven components of the powertrain, such as a transmission connected to drive wheels, electric machines that power systems onboard and offboard systems, or hydraulic pumps that power hydraulic systems, can be connected to the engine through a friction drive or a traction drive, such as a clutch connection to the flywheel. For hybrid power applications in which the power unit is subject to meet unpredictably varying loads, however, the second power unit is preferably integrated as a power take off (“PTO”) from the crankshaft via a positive drive coupling. In this way, the second power unit is constantly connected to the engine output to rapidly store surplus power the engine may generate during low loads and boost the engine output using stored energy to meet high loads.

However, such connections can be problematic. For example, some components, like an electric machine, cannot withstand the torque peaks that the engine outputs if connected for prolonged periods, as would be needed in a hybrid powertrain. Space constraints can also limit the ability to connect components such as an electric machine downstream of the flywheel. Because of space constraints, it can be preferable to mount an electric machine on the engine and to drive the electric machine off the crankshaft. Therefore, a need exists for a device for connecting a hybrid powertrain component, such as an electric machine, directly to the crankshaft output of a piston driven internal combustion engine that limits the engine's torque output to avoid damage to the hybrid powertrain component.

### SUMMARY OF THE DISCLOSURE

According to one embodiment, the techniques described herein relate to a hybrid powertrain including: an internal combustion engine configured to rotate a crankshaft output with an engine torque. The crankshaft output is coupled to rotate an electric machine output shaft of an electric machine via a friction slip coupling. The friction slip coupling includes a first coupling shaft coupled to the crankshaft output via a first positive drive. The first coupling shaft is coaxially aligned along a rotational axis with a second coupling shaft and the second coupling shaft is coupled to the electric machine via a second positive drive. A disc pack is attached between the first coupling shaft and the second coupling shaft and has a set torque which is a maximum torque the disc pack can transfer from the first coupling shaft to rotate the second coupling shaft without slipping. The friction slip coupling limits the engine torque transmitted to the electric machine output shaft based on the set torque.

According to some aspects, the disc pack includes a set of friction discs coupled to rotate with one of the first coupling shaft and the second coupling shaft, a set of drive discs coupled to rotate with the other of the first coupling shaft and the second coupling shaft. The disc pack also includes an engagement spring configured to apply an axial engagement force compressing the set of friction discs against the set of drive discs to frictionally couple the first coupling shaft to rotate with the second coupling shaft and thereby control the set torque.

According to other aspects, the engine produces a peak torque at crankshaft output, and the set torque is less than the peak torque.

According to yet other aspects, at least one of the first coupling shaft and the second coupling shaft includes an oil channel that permits a flow from an oil supply around the disc pack.

According to still other aspects, the electric machine is configured to receive electrical power and drives the electric machine output shaft to boost the power output of the crankshaft output.

According to further aspects, the crankshaft output drives the electric machine to generate electrical power.

According to yet further aspects, the friction slip coupling is fixedly mounted on the engine.

According to still further aspects, the electric machine is fixedly mounted on the friction slip coupling.

According to another embodiment, the techniques described herein relate to a method of operating a hybrid powertrain including: providing an internal combustion engine configured to rotate a crankshaft output, wherein the crankshaft output is coupled to rotate an electric machine output shaft of an electric machine via a friction slip coupling. The friction slip coupling includes a first coupling shaft coupled to the crankshaft output to rotate with an engine torque via a first positive drive. The first coupling shaft coaxially is aligned along a rotational axis with a second coupling shaft and the second coupling shaft is coupled to the electric machine via a second positive drive. A disc pack attached between the first coupling shaft and the second coupling shaft, wherein the disc pack has a set torque which is a maximum torque the disc pack can transfer from the first coupling shaft to rotate the second coupling shaft without slipping. The friction slip coupling limits the engine torque transmitted to the electric machine output shaft based on the set torque; operating the internal combustion engine to rotate the crankshaft output to drive the first coupling shaft with an engine torque.

According to some aspects, the method includes operating the engine so that the engine torque reaches a peak torque which is greater than the set torque and driving the second coupling shaft to rotate to transmit no more than the set torque.

According to other aspects, the method of operating a hybrid powertrain includes providing at least one of the first coupling shaft and the second coupling shaft with an oil channel that permits a flow from an oil supply around the disc pack.

According to yet other aspects, the method further includes supplying the electric machine with electrical power to drive the electric machine output shaft to boost the crankshaft output.

According to still other aspects, the techniques described herein relate to a method wherein the electric machine output shaft drives an electric machine, and the method further includes operating the engine to drive the electric machine to generate electrical power.

According to further aspects, the techniques described herein relate to a method wherein the friction slip coupling is fixedly mounted on the engine.

According to still further aspects, the techniques described herein relate to a method wherein the electric machine is fixedly mounted on the friction slip coupling.

### BRIEF DESCRIPTION OF THE DRAWINGS

FIG. 1 is an isometric view of a first subassembly of one embodiment of a hybrid powertrain including an internal combustion engine block coupled to an electric machine via a friction slip coupling.

FIG. 2 is a top view of another subassembly of components of the hybrid powertrain of FIG. 1.

FIG. 3 is a partial cross-sectional view of the first subassembly, showing a cross section of friction slip coupling and the electric machine.

FIG. 4 is a graph showing the measured torque output of an internal combustion engine and the set torque of a coupled slip friction coupling as it rotates through a full engine cycle.

### DETAILED DESCRIPTION

The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure.

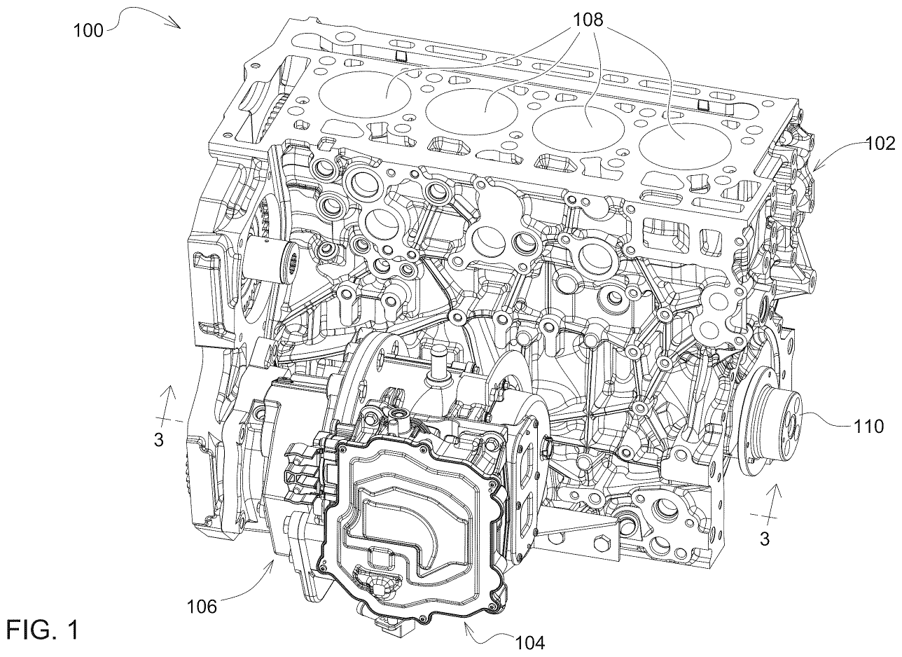

A work machine can be powered by a hybrid powertrain with a power unit that includes a piston-driven internal combustion engine and an electric machine 104. A first subassembly 100 of some components of an exemplary embodiment of the power unit is shown in FIG. 1. The piston-driven internal combustion has an engine block 102 which includes four cylinders 108. Each cylinder 108 houses a piston which can slide within its cylinder in a reciprocating motion to rotate a crankshaft 110. A connecting rod connects each piston to a corresponding rod bearing journal on crankshaft 110 which is offset from the crankshaft's central rotational axis, so that crankshaft 110 converts the reciprocating motion of each piston into the rotary motion of the crankshaft 110. A friction slip coupling 106 connects electric machine 104 to a crankshaft output. Both friction slip coupling 106 and electric machine 104 are preferably bolted or otherwise fixedly mounted onto engine block 102 so that gears and shafts that interconnect crankshaft 110, friction slip coupling 106, and electric machine 104 maintain their alignment despite vibrations during operation of the powertrain.

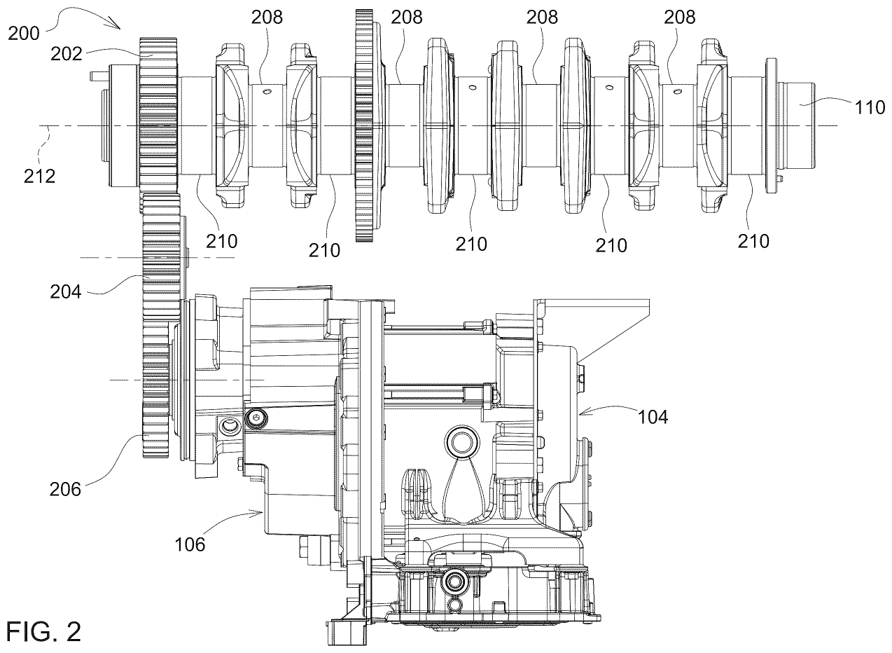

According to one embodiment of the hybrid powertrain, a second subassembly 200 of components can include crankshaft 110 coupled to electric machine 104 via friction slip coupling 106, as shown in FIG. 2. Crankshaft 110 can be mounted at the bottom of engine block 102 on main bearing journals 210 to rotate about a central axis 212. Connecting rods (not shown) connect each piston (not shown) to corresponding rod end bearings 208. Rod end bearings 208 are offset from central axis 212 so that the reciprocal motion of the connected pistons causes crankshaft 110 to rotate. Crankshaft 110 includes a crankshaft output 202 which is a gear with teeth that engage teeth of an intermediate idler gear 204 which, in turn, engage teeth of friction slip drive gear 206 of friction slip coupling 106. The engaged gear teeth of crankshaft output 202, idler gear 204, and friction slip drive gear 206 represent a positive drive connecting the crankshaft output 202 of the engine to friction slip drive gear 206 of friction slip coupling. Unlike a traction drive such as a clutch which permits slippage between connected drive elements and relies on friction to transmit torque, a positive drive transmits torque through the interaction of interlocking members such as gears, cogs or chains. The positive drive coupling provides continuous engagement between crankshaft output 202 and friction slip coupling 106 without slippage that can result from deterioration of a traction drive over time. A flywheel (not shown) can be attached to the end of crankshaft 110 adjacent crankshaft output 202.

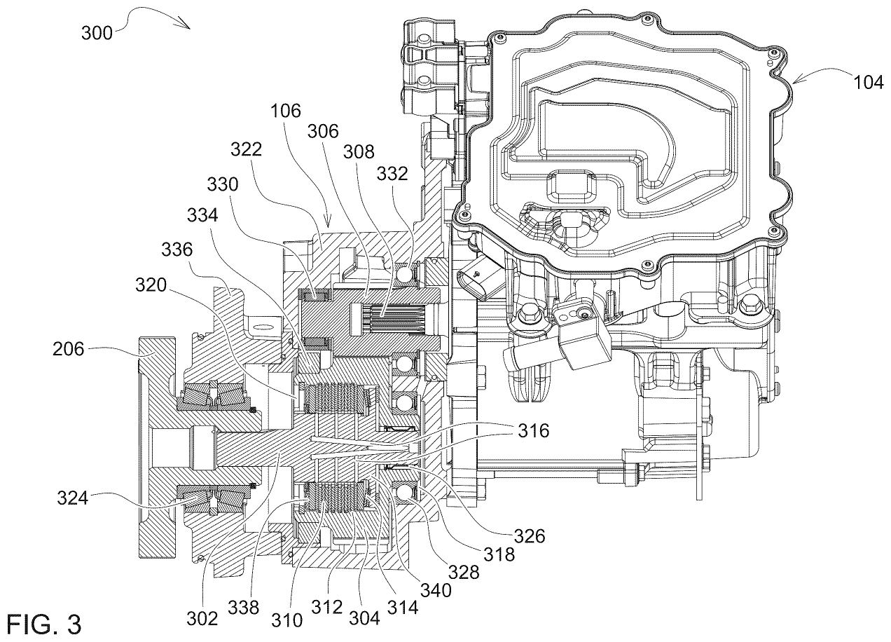

FIG. 3 is a partial cross-sectional view of first subassembly 100, showing a cross section of friction slip coupling 106 coupled to an electric machine output shaft 308 of electric machine 104. Electric machine 104 is shown in elevation view. Friction slip coupling 106 includes a housing formed from a back housing 322 mated with a front housing 336 which encloses a first coupling shaft 302 coupled to drive a second coupling shaft 304 via a disc pack. The first coupling shaft 302 is coaxially mounted in friction slip coupling 106 and aligned to rotate along a common rotational axis with second coupling shaft 304. The second coupling shaft 304 is a hollow shaft with a central cavity, concentric with the rotational axis, into which first coupling shaft 302 extends. Second coupling shaft 304 is mounted to rotate in the housing on second coupling shaft bearings 328, 334. First coupling shaft 302 is mounted to rotate in the housing on first coupling shaft main bearing 324 and minor bearing 326 between the outer surface of first coupling shaft 302 and inner wall of second coupling shaft 304. Minor bearing 326 permits rotation of first coupling shaft 302 relative to second coupling shaft 304 when torque rotating first coupling shaft 302 exceeds a set torque of the disc pack allowing for slippage between the two shafts.

The disc pack includes alternating friction discs 310 and drive discs 312 arranged around first coupling shaft 302 and coaxially along the rotational axis within the cavity of second coupling shaft 304. In this alternating arrangement, each friction disc 310 has at least one surface adjacent to a surface of a drive disc 312, so that if pressed together, their surfaces can abut and engage to generate a friction force along their engaged surfaces that tends to resist slippage of friction discs 310 relative to drive discs 312. The surfaces of friction discs 310 that abut drive discs surfaces are designed to reliably generate a narrow range of friction forces depending on the force compressing friction disc surfaces to engage against drive discs surfaces within the expected temperature range of the discs in operation. Disc temperature can affect the frictional properties of friction discs 310 and drive discs 312 and, therefore, the coefficient of friction between the discs. Either one of the friction discs 310 or drive discs 312 can be splined or keyed to rotate with first coupling shaft 302 and the other splined or keyed to rotate with second coupling shaft 304. FIG. 3 shows friction discs 310 rotationally fixed to first coupling shaft 302 and drive discs 312 rotationally fixed to second coupling shaft 304. Accordingly, whenever first coupling shaft 302 slips and rotates relative to second coupling shaft 304, friction discs 310 rotate with first coupling shaft 302 in an opposite direction, relatively, to drive discs 312.

Although locked to rotate with first coupling shaft 302 or with second coupling shaft 304, friction discs 310 and drive discs 312 can have some limited movement in the axial direction, parallel to the rotational axis between flange 340 on first coupling shaft 302 and end plate 338. An engagement spring 314, such as a Belleville arranged around first coupling shaft 302, can be located between flange 340, on the one hand, and friction discs 310 and drive discs 312 on the other. Engagement spring 314 is biased to apply an axial engagement force which presses adjacent surfaces of friction discs 310 and drive discs 312 together. The axial engagement force can be adjusted based on the selection and design of engagement spring 314. The magnitude of the engagement force determines the maximum friction force that can be generated between friction discs 310 and drive discs 312 to resist the force produced by the torque applied to first coupling shaft 302 tending to rotate the shaft and its connected friction discs 310 relative to second coupling shaft 304 and its connected drive discs 312.

Second coupling shaft 304 has an outer peripheral surface which includes gear teeth that engage with electric machine drive gear 306. Electric machine drive gear 306 is splined to rotate electric machine output shaft 308 with a selected gear ratio. The engaged teeth of these gears and splines provide a second positive drive coupling between second coupling shaft and electric machine output shaft 308. Electric machine drive gear 306 can be mounted in the housing to rotate on electric machine drive gear bearings 330, 332. When powered to rotate by engine through crankshaft output 202 and friction slip drive gear 206, electric machine 104 can be controlled to generate electricity which can be stored in electrical energy storage devices such as batteries or capacitors electrically connected to electric machine 104. Second coupling shaft 304 must produce sufficient torque to rotate electric machine output shaft 308 and produce the work electric machine 104 consumes in generating the electricity. This torque appears as a resistance first coupling shaft 302 overcomes to rotate second coupling shaft 304 in driving electric machine 104 to generate electricity. Alternatively, electric machine 104 can be controlled operate as a motor to receive from the electrical energy storage devices to rotate electric machine output shaft 308 to drive crankshaft output 202 through friction slip drive gear 206 and friction slip drive gear 206 to boost the power the engine outputs through its flywheel.

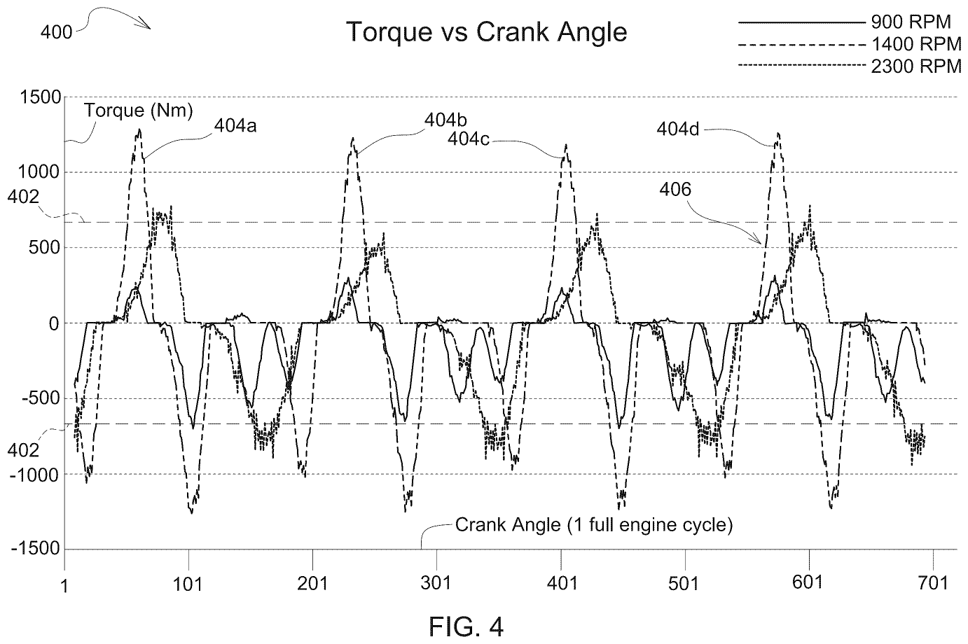

According to one embodiment, the internal combustion engine can be a four-stroke engine with each upward or downward stroke representing a half turn, or 180 degrees rotation of crankshaft 110. In operation, the engine ignites a fuel and air mixture in the combustion chamber of each cylinder sequentially to produce a combustion stroke once every fourth stroke. Completing a full engine cycle of a combustion stroke in each of the four cylinders of engine block 102 requires two rotations of crankshaft 110, which is a rotation through 720 degrees. FIG. 4 is a graph showing the measured torque output (in Newton meters, Nm) of the internal combustion engine with the powertrain subassembly 100 as crankshaft 110 rotates through a full engine cycle. The graph shows torque output measurements with the engine operating at 900 rpm, 1400 rpm, and 2300 rpm plotted with different line types as shown in the graph's legend. At each speed, the torque the engine produces has a characteristic peak caused by the downward force of one of the four pistons during a combustion stroke rotating crankshaft 110. For example, the largest torque peaks 404a, 404b, 404c, 404d are produced by the engine running at 1400 rpm with peaks of about 1250 Nm. Torque peaks of this magnitude can cause excessive wear and possibly damage electric machine 104 and the drive train.

To avoid this damage or excessive wear on electric machine 104, engagement spring 314 can be selected to adjust set torque 402 in friction slip coupling 106 to limit the torque transmitted from crankshaft output 202 to electric machine output shaft 308. For example, engagement spring 314 can be selected to adjust set torque 402 to about 600 Nm as shown in FIG. 4. The set torque 402 can generally be dependent on the axial engagement force with which engagement spring 314 presses the abutting surfaces of friction discs 310 and drive discs 312 together, given a coefficient of friction between the discs. Thus, adjusting set torque 402 involves selecting an engagement spring that generates the appropriate axial engagement force needed to produce a desired maximum friction force across the range of disc temperatures expected during operation. With set torque 402 adjusted to 600 Nm, the disc pack does not transmit more than 600 Nm from crankshaft output 202 to electric machine output shaft 308. If crankshaft output 202 produces more than 600 Nm, the torsional force tending to rotate friction discs 310 against the load of electric machine output shaft 308 acting through drive discs 312 exceeds the maximum friction force that the engagement force between friction discs 310 and drive discs 312 can generate. Whenever the torsional force tending to rotate friction discs 310 against drive discs 312 exceeds the maximum friction force that the axial engagement force can generate, the friction discs 310 begin slipping on drive discs 312 and generate heat. Because the set torque is less than the peak torque the engine outputs, only the torque produced by the friction force in drive discs 312 is transmitted to rotate the second coupling shaft 304.

To avoid excessive temperatures in friction discs 310 and drive discs 312 caused by overheating through slippage, friction slip coupling 106 can include cooling systems to control friction disc 310 and drive disc 312 temperature. Optionally, friction slip coupling 106 can include oil channels that route a fluid coolant, such as oil around friction discs 310 and drive discs 312. In the embodiment shown in FIG. 3, friction slip coupling 106 circulates oil through oil supply gallery 318 and oil return gallery 320. First coupling shaft 302 can include oil channels 316 which can route cooling oil from oil supply gallery 318 to flow around friction discs 310 and drive discs 312 where the cooling oil picks up the heat and conducts it away as it discharges through oil return gallery 320. The engine can include dedicated pumps to circulate the cooling oil through the galleries and channels of friction slip coupling 106. Alternatively, channels in rotating components, such as oil channels 316 in first coupling shaft 302 can be configured to induce an oil pressure gradient between oil supply gallery 318 and oil return gallery 320 to assist pumping cooling oil around hot components such as friction discs 310 and drive discs 312. Oil channels 316 are routed, or otherwise configured, so that when the rotating components rotate during operation of the engine, centrifugal forces acting on the cooling oil in the oil channels 316 generate a pressure gradient that induces the cooling oil to flow through oil channels 316 from oil supply gallery 318 to oil return gallery 320.

One embodiment is directed to a method of operating a hybrid powertrain which includes providing an internal combustion engine with a crankshaft output which is coupled to rotate an electric machine output shaft of an electric machine via a friction slip coupling. The friction slip coupling includes a first coupling shaft coupled to the crankshaft output which applies an engine torque to rotate the first coupling shaft via a first positive drive. The friction slip coupling also includes a second coupling shaft which is coaxially aligned along a rotational axis with the first coupling shaft. The second coupling shaft is coupled to the electric machine via a second positive drive, and a disc pack is attached between the first coupling shaft and the second coupling shaft. The disc pack has a set torque which is a maximum torque the disc pack can transfer from the first coupling shaft to rotate the second coupling shaft without slipping and limits the engine torque transmitted to the electric machine output shaft based on the set torque. The method can involve operating the engine to rotate at a speed, such as at 1400 rpm, and to output a varying torque as shown by the torque output plot 406, shown in dashed line in FIG. 4. During each full engine cycle, the crankshaft output 202 produces four torque peaks, 404a, 404b, 404c, and 404d, each representing a peak torque of about 1250 Nm. An engagement spring in the disc pack can be selected to limit the torque output the friction slip coupling transmits to the electric machine output shaft 308 to a set torque 402 of about 600 Nm, so that the engine reaches one or more torque peaks which are greater than the set torque. The method further includes operating the first coupling shaft to begin slipping and thereby rotating relative to the second coupling shaft as the torque produced by the crankshaft output exceeds the set torque of 600 Nm so that the torque transmitted to electric machine output does not exceed the set torque value.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1. A hybrid powertrain comprising:
an internal combustion engine configured to rotate a crankshaft output with an engine torque, wherein the crankshaft output is coupled to rotate an electric machine output shaft of an electric machine via a friction slip coupling;
wherein the friction slip coupling includes a first coupling shaft coupled to the crankshaft output via a first positive drive, the first coupling shaft coaxially aligned along a rotational axis with a second coupling shaft, the second coupling shaft coupled to the electric machine via a second positive drive, and a disc pack attached between the first coupling shaft and the second coupling shaft,
wherein the disc pack has a set torque which is a maximum torque the disc pack can transfer from the first coupling shaft to rotate the second coupling shaft without slipping, and wherein the friction slip coupling limits the engine torque transmitted to the electric machine output shaft based on the set torque.

2. The hybrid powertrain of claim 1 wherein the disc pack includes a set of friction discs coupled to rotate with one of the first coupling shaft and the second coupling shaft, a set of drive discs coupled to rotate with the other of the first coupling shaft and the second coupling shaft, and an engagement spring configured to apply an axial engagement force compressing the set of friction discs against the set of drive discs to frictionally couple the first coupling shaft to rotate with the second coupling shaft and thereby control the set torque.

3. The hybrid powertrain of claim 2, wherein the engine produces a peak torque at crankshaft output, and wherein the set torque is less than the peak torque.

4. The hybrid powertrain of claim 1, wherein at least one of the first coupling shaft and the second coupling shaft includes an oil channel that connects an oil supply gallery to an oil return gallery via the disc pack, wherein the oil channel is configured to generate an oil pressure gradient between the oil supply gallery and the oil return gallery whenever the oil channel rotates during engine operation.

5. The hybrid powertrain of claim 1, wherein the electric machine is configured to receive electrical power and drives the electric machine output shaft to boost the power output of the crankshaft output.

6. The hybrid powertrain of claim 1, wherein the crankshaft output drives the electric machine to generate electrical power.

7. The hybrid powertrain of claim 1, wherein the friction slip coupling is fixedly mounted on the engine.

8. The hybrid powertrain of claim 7, wherein the electric machine is fixedly mounted on the friction slip coupling.

9. A method of operating a hybrid powertrain comprising:
providing an internal combustion engine configured to rotate a crankshaft output, wherein the crankshaft output is coupled to rotate an electric machine output shaft of an electric machine via a friction slip coupling,
wherein the friction slip coupling includes a first coupling shaft coupled to the crankshaft output to rotate with an engine torque via a first positive drive, the first coupling shaft coaxially aligned along a rotational axis with a second coupling shaft, the second coupling shaft coupled to the electric machine via a second positive drive, and a disc pack attached between the first coupling shaft and the second coupling shaft,
wherein the disc pack has a set torque which is a maximum torque the disc pack can transfer from the first coupling shaft to rotate the second coupling shaft without slipping, and wherein the friction slip coupling limits the engine torque transmitted to the electric machine output shaft based on the set torque;
operating the internal combustion engine to rotate the crankshaft output to drive the first coupling shaft with an engine torque.

10. The method of operating the hybrid powertrain of claim 9, further comprising operating the engine so that the engine torque reaches a peak torque which is greater than the set torque and driving the second coupling shaft to rotate to transmit no more than the set torque.

11. The method of operating the hybrid powertrain of claim 9, wherein at least one of the first coupling shaft and the second coupling shaft includes an oil channel that permits a flow from an oil supply around the disc pack.

12. The method of operating the hybrid powertrain of claim 9 wherein the electric machine output shaft drives an electric machine, and wherein the method further comprises supplying the electric machine with electrical power to drive the electric machine output shaft to boost the crankshaft output.

13. The method of operating the hybrid powertrain of claim 9 wherein the electric machine output shaft drives an electric machine, and wherein the method further comprises operating the engine to drive the electric machine to generate electrical power.

14. The method of operating the hybrid powertrain of claim 9, wherein the friction slip coupling is fixedly mounted on the engine.

15. The method of operating the hybrid powertrain of claim 14, wherein the electric machine is fixedly mounted on the friction slip coupling.
